(19) United States
(12) Patent Application Publication
(10) Pub. No.: US 2026/0233366 A1
(43) Pub. Date: Aug. 13, 2026

(54) POWERED RATCHET TOOL WITH BALANCED CRANKSHAFT

(71) Applicant: MILWAUKEE ELECTRIC TOOL CORPORATION, Brookfield, WI (US)

(72) Inventor: Kyle A. Marten, Plymouth, WI (US)

(21) Appl. No.: 19/538,226

(22) Filed: Feb. 12, 2026

Related U.S. Application Data
(60) Provisional application No. 63/758,032, filed on Feb. 13, 2025.

(51) Int. Cl. B25B 21/00; B25F 5/00

(52) U.S. Cl. CPC B25B 21/004; B25F 5/001

(57) ABSTRACT

A powered ratchet tool includes a housing, a motor having an output shaft rotatable about a first axis, a rotating assembly operably coupled to the output shaft, the rotating assembly including a crankshaft rotatable about the first axis, the crankshaft further including an eccentric member and a drive bushing supported by the eccentric member, a ratchet mechanism including a yoke coupled to the drive bushing such that rotation of the crankshaft about the first axis causes the yoke to reciprocate a second axis, an output drive extending from the yoke to receive a tool element, and a counterweight coupled to the rotating assembly. The eccentric member defines a third axis parallel to the first axis, and the counterweight is positioned on a side of the first axis opposite the third axis to balance a combined weight of the eccentric member and the drive bushing.

### CROSS-REFERENCE TO RELATED APPLICATIONS

The present application claims priority to U.S. Provisional Patent Application No. 63/758,032, filed February 13, 2025, the entire content of which is incorporated herein by reference.

### FIELD

The present disclosure relates to power tools, and more particularly to powered ratchet tools.

### BACKGROUND

Powered ratchet tools typically include a motor (e.g., an electric motor or a pneumatic motor) operably coupled to a crankshaft. The crankshaft is coupled to a yoke housing via an eccentric bushing. As such, when the crankshaft is driven by the motor, the crankshaft causes the yoke housing to rotate back and forth in a reciprocating manner about an axis.

### SUMMARY

Due to the eccentric position of the output of the crankshaft, rotation of the crankshaft may cause the powered ratchet tool to vibrate, which can lead to operator fatigue and reduced precision. Accordingly, a need exists for a powered ratchet tool with reduced vibration.

In some aspects, the techniques described herein relate to a powered ratchet tool including: a housing; a motor supported within the housing, the motor including an output shaft rotatable about a first axis; a rotating assembly operably coupled to the output shaft of the motor to be driven by the motor, the rotating assembly including a crankshaft rotatable about the first axis, the crankshaft further including an eccentric member and a drive bushing supported by the eccentric member; a ratchet mechanism including a yoke rotatably supported by the housing and coupled to the drive bushing such that rotation of the crankshaft about the first axis causes the yoke to reciprocate a second axis perpendicular to the first axis; an output drive extending from the yoke and configured to receive a tool element; and a counterweight coupled to the rotating assembly, wherein the eccentric member defines a third axis parallel to the first axis, and wherein the counterweight is positioned on a side of the first axis opposite the third axis to balance a combined weight of the eccentric member and the drive bushing.

In some aspects, the techniques described herein relate to a powered ratchet tool, wherein the counterweight is a protrusion integrally formed with the crankshaft as a single piece.

In another aspect, the techniques described herein relate to a powered ratchet tool comprising a housing, a motor having an output shaft rotatable about a first axis, a crankshaft rotatable about the first axis and including an eccentric member defining a third axis parallel to the first axis, a drive bushing supported on the eccentric member, a yoke coupled to the drive bushing and configured to reciprocate about a second axis in response to rotation of the crankshaft, an output drive extending from the yoke, and a counterweight integrally formed with the crankshaft as a single piece, the counterweight positioned radially opposite the third axis to offset a mass of the eccentric member and the drive bushing.

In another aspect, the techniques described herein relate to a powered ratchet tool comprising a housing, a motor including an output shaft rotatable about a first axis, a planetary gear transmission driven by the output shaft, the transmission including a carrier, a crankshaft engaged with the carrier and including an eccentric member and a drive bushing, a yoke coupled to the drive bushing for reciprocating movement about a second axis, an output drive extending from the yoke and a counterweight mounted to the carrier.

Other features and aspects of the present disclosure will become apparent upon consideration of the following description and accompanying drawings.

### BRIEF DESCRIPTION OF DRAWINGS

FIG. 1 is a side view of a powered ratchet tool according to an embodiment of the present disclosure.

FIG. 2 is a cross-sectional view of the powered ratchet tool of FIG. 1.

FIG. 3 is a cross-sectional view of the powered ratchet tool of FIG. 1, taken along line 3—3 in FIG. 1.

FIG. 4 is a plan view illustrating a portion of a crankshaft and a yoke of the powered ratchet tool of FIG. 1, with the crankshaft including a counterweight according to an embodiment of the present disclosure.

FIG. 5 is a perspective view illustrating a portion of a crankshaft including a counterweight according to another embodiment of the present disclosure and which may be incorporated into the powered ratchet tool of FIG. 1.

FIG. 6 is a perspective view illustrating the crankshaft of FIG. 5 coupled to the yoke of the powered ratchet tool of FIG. 1.

FIG. 7 is a perspective view illustrating a counterweight according to another embodiment, which may be incorporated into a planet carrier of the powered ratchet tool of FIG. 1.

FIG. 8 illustrates a connection interface between the crankshaft and the planet carrier of FIG. 6.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

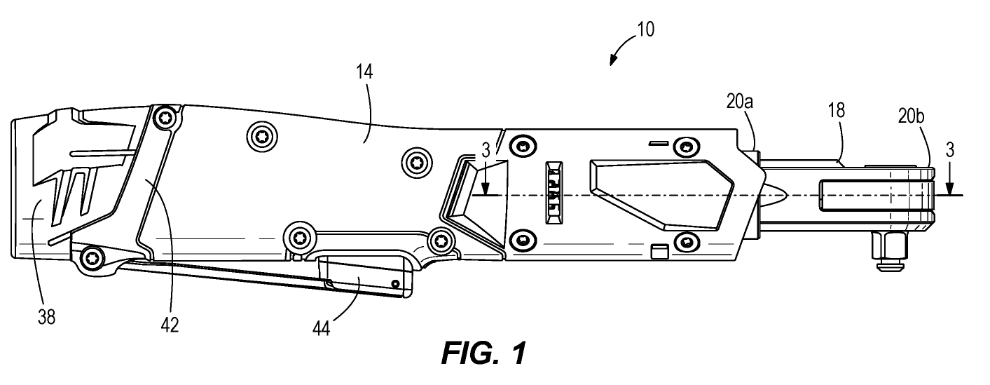

With reference to FIGS. 1-3, a powered ratchet tool 10 in accordance with an embodiment of the disclosure includes a handle housing 14 and a front housing or yoke housing 18 coupled to the handle housing 14. The handle housing 14 and the yoke housing 18 may collectively define a housing of the powered ratchet tool 10. In the illustrated embodiment, a portion of the yoke housing 18 is received within and captured between halves of the handle housing 14. The handle housing 14 is a clamshell housing made of a molded plastic material and configured to be grasped by a user during operation, while the yoke housing 18 is a metal housing. The yoke housing 18 has a first end portion 20a disposed within the handle housing 14 and a second end portion 20b extending from the handle housing 14.

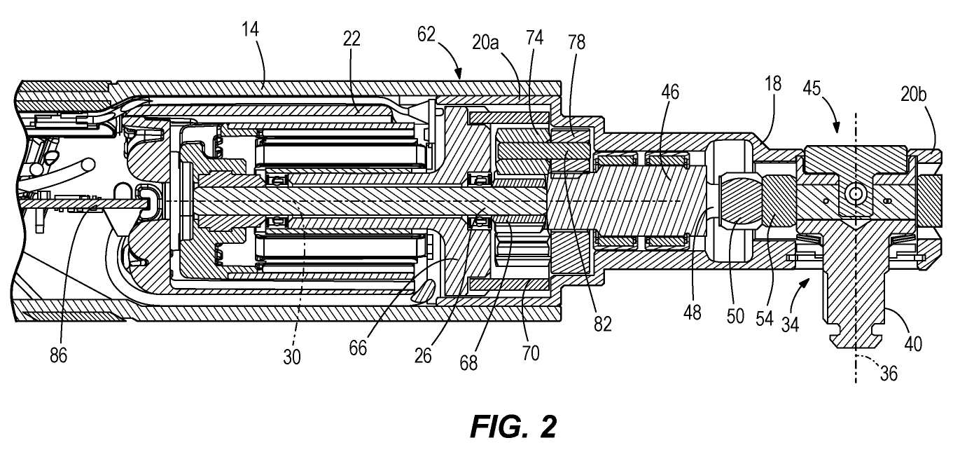

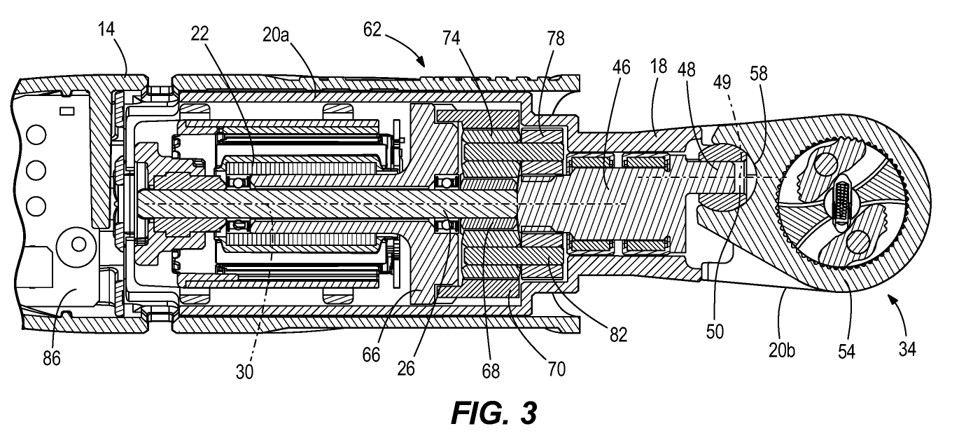

The powered ratchet tool 10 further includes a motor 22 that is supported within the yoke housing 18 (FIGS. 2-3). In the illustrated embodiment, the motor 22 has an output shaft 26 rotatable about a first axis 30 and configured to provide torque to an output drive 34 rotatably supported by the yoke housing 18 for rotation about a second axis 36 perpendicular to the first axis 30. The illustrated output drive 34 includes a square drive interface 40, which may be sized to receive standardized sockets (e.g., 3/8”, 1/2", 3/4", 1”, etc.). The output drive 34 is configured to be coupled to a socket or other tool element (not shown) that performs work on a workpiece (e.g., a fastener, bit, or the like).

In the illustrated embodiment, the motor 22 is an electric motor, such as a brushless DC motor. In some embodiments, the motor 22 is a surface permanent magnet (SPM) motor including a stator, a rotor, and permanent magnets affixed to or embedded in an exterior surface of the rotor. In other embodiments, the motor 22 is an outer rotor motor, having a rotor that surrounds and rotates about the stator. In yet other embodiments, the motor 22 may be a pneumatic motor with a turbine driven by a source of compressed air.

In the illustrated embodiment, the ratchet tool 10 includes a battery pack 38 received by a battery receptacle 42 formed in the handle housing 14 opposite the yoke housing 18. The battery receptacle 42 electrically connects the battery pack 38 to the motor 22 via a PCBA 86 (other suitable electrical and electronic components may include a PCBA containing MOSFETs, IGBTs, or the like). The battery pack 38 may be a 12-volt power tool battery pack that includes three lithium-ion battery cells. Alternatively, the battery pack 38 may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 10 also includes an actuator 44 for controlling operation of the ratchet tool 10 (e.g., to energize/de-energize the motor 22). In the illustrated embodiment, the actuator 44 is a push-button that can be depressed into the handle housing 14 to energize the motor 22. The illustrated actuator 44 extends from the handle housing 14 in the same direction as the output drive 34.

With reference to FIGS. 2 and 3, the powered ratchet tool 10 further includes a ratchet mechanism 45 supported by the yoke housing 18. The ratchet mechanism 45 has a crankshaft 46 with an eccentric member 48 and a drive bushing 50 arranged on the eccentric member 48 of the crankshaft 46. In the illustrated embodiment, the eccentric member 48 is a cylindrical pin integrally formed with the remainder of the crankshaft 46. In other embodiments, the eccentric member 48 may be formed separately and coupled to the crankshaft 46 via any suitable method (e.g., press fitting or the like). The eccentric member 48 extends along a third axis 49 parallel to the first axis 30 (FIG. 3). As such, when the crankshaft 46 is driven by the motor 22 to rotate about the first axis 30, the eccentric member 48 and the bushing 50 orbit about the first axis 30. The ratchet mechanism 45 further includes a yoke 54 through which the output drive 34 extends. The yoke 54 has a recess 58 in which the drive bushing 50 is arranged. Thus, when the crankshaft 46 is rotated, the drive bushing 50 pivots the yoke 54 in a reciprocating manner to drive the output drive 34 about the second axis 36.

With continued reference to FIGS. 2 and 3, the crankshaft 46 of the ratchet mechanism 45 is operably coupled to the output shaft 26 of the motor 22 via a transmission 62 also supported within the yoke housing 18. The transmission 62 includes a first planet carrier 66, a pinion 68, a ring gear 70 coupled to the first planet carrier 66, a plurality of planet gears 74, and a second planet carrier 78. The pinion 68 is coupled to the output shaft 26 of the motor 22 for rotation about the first axis 30. The plurality of planet gears 74 are meshed with both the pinion 68 and the ring gear 70. Pins 82 are used to couple the plurality of planet gears 74 with the second planet carrier 78. The second planet carrier 78 engages the crankshaft 46 to drive rotation of the crankshaft 46 to operate the ratchet mechanism 45.

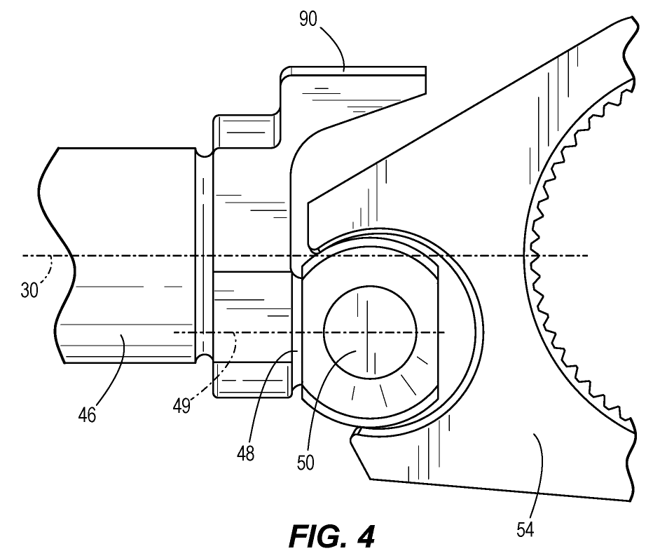

With reference to FIG. 4, the illustrated crankshaft 46 includes a counterweight 90 that is positioned on a side of the first axis 30 opposite of the eccentric member 48 and the third axis 49. The counterweight 90 is sized such that its weight and position result in a force that counteracts the initial unbalancing force of the eccentric member 48 and drive bushing 50. In the embodiment illustrated in FIG. 4, the counterweight 90 is integrally formed as a single piece with the crankshaft 46 as a protrusion that extends towards the yoke 54. The counterweight 90 is shaped and positioned to avoid contact with the yoke 54, as the yoke 54 pivots in a reciprocating manner.

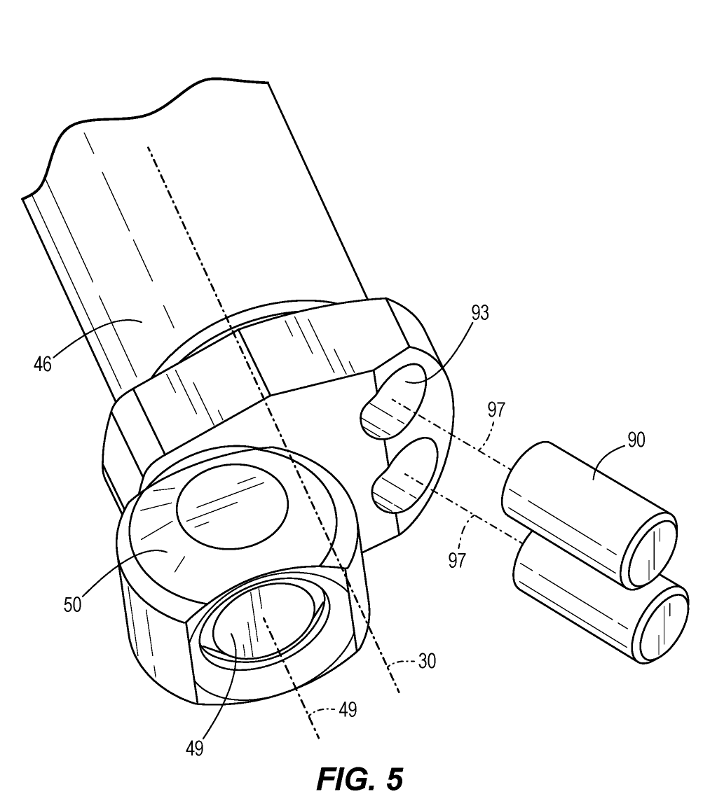

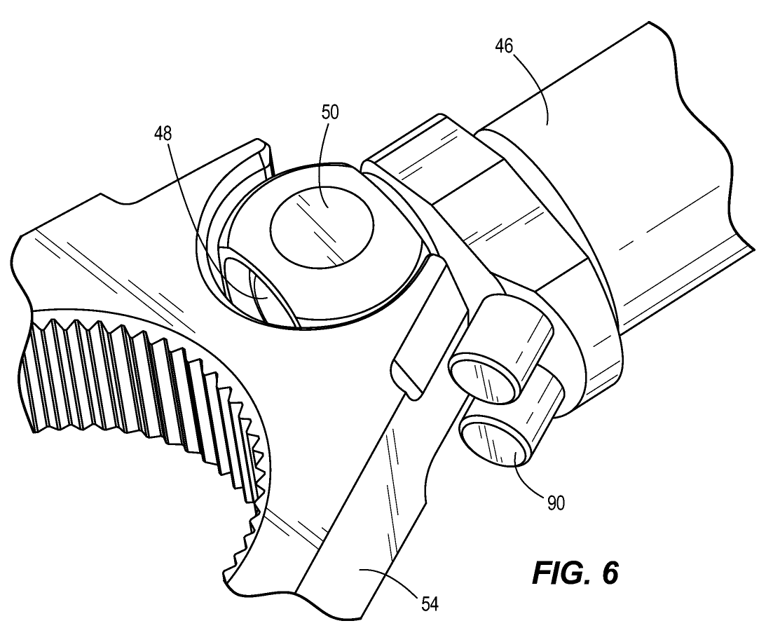

FIGS. 5-6 illustrate a counterweight 90 according to another embodiment, where the counterweight 90 is formed separately from the crankshaft 46. In this embodiment the counterweight 90 includes two cylindrically shaped pins that are pressed into corresponding bores 93 in the crankshaft 46 formed on a side of the first axis 30 opposite the third axis 49. The pins extend along respective parallel axes 97, which in the illustrated embodiment are not parallel to the first and third axes 30, 49. In other words, the pins defining the counterweight 90 in the illustrated embodiment are oriented at an oblique angle relative to the first and third axes 30, 49. This angle may advantageously minimize the width of the crankshaft 46 required to accommodate the counterweight 90 and prevent contact between the yoke 54 and the counterweight 90. In other embodiments, the counterweight 90 may include pins or other shaped inserts in any number or arrangement suitable for balancing the crankshaft 46.

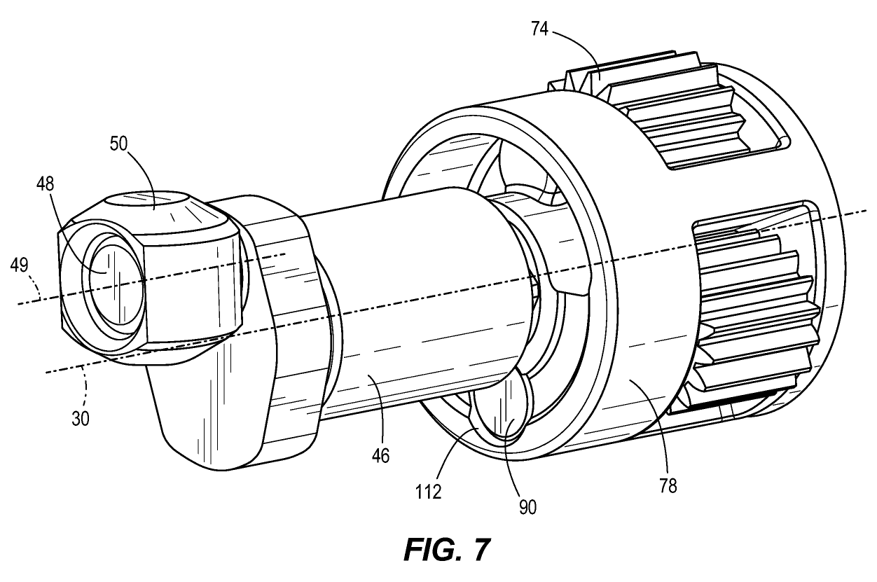

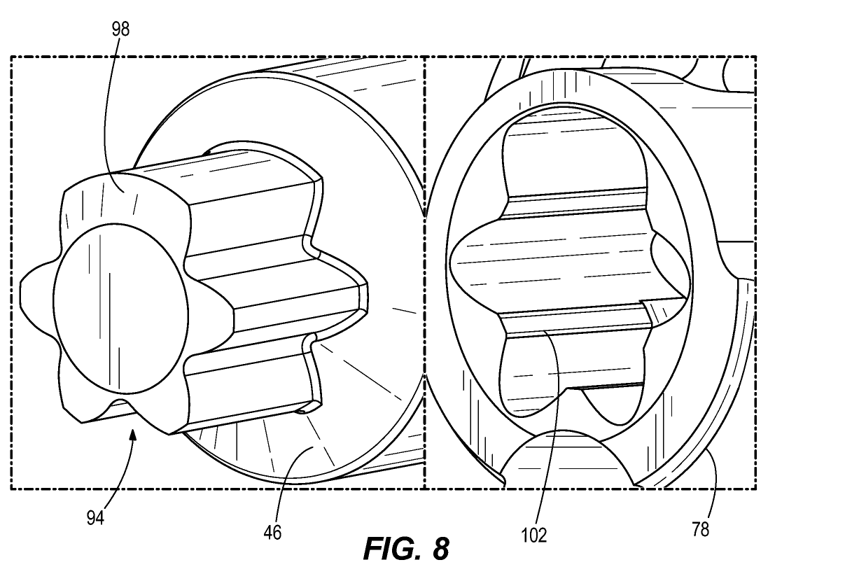

FIGS. 7-8 depict yet another alternative embodiment, where the counterweight 90 is disposed on the second planet carrier 78. The counterweight 90 is radially spaced from the first axis 30 and is 180 degrees out of phase with the eccentric member 48. The illustrated counterweight 90 is a cylindrically shaped pin that is pressed into a corresponding bore 112 in the second planet carrier 78. To ensure the counterweight 90 is positioned correctly during assembly, the crankshaft 46 includes an asymmetrical spline 94 having a single tooth 98 of the spline 94 is wider than the other teeth and similarly shaped female spline 102 on the second planet carrier 78 (FIG. 8). This ensures that the crankshaft 46 only fits in one position with the second planet carrier 78, where the counterweight 90 is 180 degrees out of phase with the eccentric member 48.

In each of the embodiments described and illustrated herein, the counterweight 90 may be made from a material of a relatively high density such as, but not limited to, steel, brass, or tungsten. Use of a high density material minimizes the size and volume of the counterweight 90 needed to balance the eccentric member 48 and drive bushing 50.

In operation, the user depresses the actuator 44 to energize the motor 22 and rotate the output shaft 26. The pinion 68 co-rotates with the output shaft 26 to rotate the plurality of planet gears 74, and thereby rotate the second planet carrier 78 to drive rotation of the crankshaft 46. The crankshaft 46 rotates the drive bushing 50, which causes the yoke 54 to pivot in a reciprocating manner relative to the yoke housing 18. The yoke 54 then transfers torque to the output drive 34 to either tighten or loosen a workpiece. The counterweight 90 balances the weight of the eccentric member 48 and the drive bushing 50 to reduce vibration that may otherwise be generated by rotation of the crankshaft 46. Thus, the powered ratchet tool 10 may be operated with less vibration and therefore improved operator comfort and reduced fatigue relative to known powered ratchet tools.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A powered ratchet tool comprising:
a housing;
a motor supported within the housing, the motor including an output shaft rotatable about a first axis;
a rotating assembly operably coupled to the output shaft of the motor to be driven by the motor, the rotating assembly including a crankshaft rotatable about the first axis, the crankshaft further including an eccentric member and a drive bushing supported by the eccentric member;
a ratchet mechanism including a yoke rotatably supported by the housing and coupled to the drive bushing such that rotation of the crankshaft about the first axis causes the yoke to reciprocate a second axis perpendicular to the first axis;
an output drive extending from the yoke and configured to receive a tool element; and
a counterweight coupled to the rotating assembly,
wherein the eccentric member defines a third axis parallel to the first axis, and
wherein the counterweight is positioned on a side of the first axis opposite the third axis to balance a combined weight of the eccentric member and the drive bushing.

2. The powered ratchet tool of claim 1, wherein the counterweight includes a protrusion extending from the crankshaft.

3. The powered ratchet tool of claim 1, wherein the counterweight is formed separately from and fixed to the crankshaft.

4. The powered ratchet tool of claim 3, wherein the counterweight includes a pin pressed into a corresponding bore in the crankshaft.

5. The powered ratchet tool of claim 3, wherein the counterweight is made from tungsten.

6. The powered ratchet tool of claim 1, wherein the rotating assembly is a planetary gear set including a plurality of planet gears, a sun gear, a ring gear, and a carrier.

7. The powered ratchet tool of claim 6, wherein the counterweight is coupled to the carrier.

8. The powered ratchet tool of claim 7, wherein the counterweight includes a cylindrical pin pressed into a corresponding cylindrical bore formed in the carrier.

9. The powered ratchet tool of claim 7, wherein the counterweight is made of tungsten.

10. A powered ratchet tool comprising:
a housing;
a motor having an output shaft rotatable about a first axis;
a crankshaft rotatable about the first axis and including an eccentric member defining a third axis parallel to the first axis;
a drive bushing supported on the eccentric member;
a yoke coupled to the drive bushing and configured to reciprocate about a second axis in response to rotation of the crankshaft;
an output drive extending from the yoke; and
a counterweight integrally formed with the crankshaft as a single piece, the counterweight positioned radially opposite the third axis to offset a mass of the eccentric member and the drive bushing.

11. The powered ratchet tool of claim 10, wherein the eccentric member is integrally formed with the crankshaft.

12. The powered ratchet tool of claim 10, wherein the counterweight extends towards the yoke and is spaced apart from the yoke to prevent contact with the yoke during operation.

13. The powered ratchet tool of claim 12, wherein at least a portion of the counterweight extends beyond a radius of rotation of the eccentric member.

14. The powered ratchet tool of claim 10, wherein the counterweight further includes a face positioned at an oblique angle relative to the first axis.

15. A powered ratchet tool comprising:
a housing; a motor including an output shaft rotatable about a first axis;
a planetary gear transmission driven by the output shaft, the transmission including a carrier;
a crankshaft engaged with the carrier and including an eccentric member and a drive bushing;
a yoke coupled to the drive bushing for reciprocating movement about a second axis; an output drive extending from the yoke; and
a counterweight mounted to the carrier.

16. The powered ratchet tool of claim 15, wherein the counterweight is positioned 180 degrees out of phase with the eccentric member to balance rotation of the crankshaft.

17. The powered ratchet tool of claim 16, wherein the counterweight comprises a cylindrical pin pressed into a bore in the carrier.

18. The powered ratchet tool of claim 15, wherein the crankshaft and the carrier include mating asymmetric spline interfaces that prevent misalignment of the counterweight relative to the eccentric member.

19. The powered ratchet tool of claim 15, wherein the carrier and the counterweight are made of different materials.

20. The powered ratchet tool of claim 19, wherein the counterweight is made from steel, brass, or tungsten.
